(19) United States
(12) Patent Application Publication
(10) Pub. No.: US 2015/0316163 A1
(43) Pub. Date: Nov. 5, 2015

(54) Valve Housing and Method for Assembling a Valve Housing

(71) Applicant: KNORR-BREMSE Systeme fuer Nutzfahrzeuge GmbH, Muenchen (DE)

(72) Inventors: Laszlo KONCZ, Kecskemet (HU); Gabor FARKAS, Kecskemet (HU); Peter Andras KOVACS, Nagykoros (HU)

(21) Appl. No.: 14/796,059

(22) Filed: Jul. 10, 2015

Related U.S. Application Data
(63) Continuation of application No. PCT/EP2014/050304, filed on Jan. 9, 2014.

(30) Foreign Application Priority Data
Jan. 11, 2013 (DE) 10 2013 100 243.9

(51) Int. Cl. F16K 27/00

(52) U.S. Cl. CPC F16K 27/00

(57) ABSTRACT

A valve housing, in particular for a level control valve and/or a rapid-action valve, is provided. The valve housing has a first housing part and a second housing part. The first housing part and the second housing part can be brought together in an assembly orientation in relation to one another in order to establish mechanical contact between the first housing part and the second housing part and can be moved out of the assembly orientation into a securing orientation in relation to one another. The first housing part and the second housing part are designed to be secured or securable to each other mechanically in the securing orientation.

### CROSS REFERENCE TO RELATED APPLICATIONS

This application is a continuation of PCT International Application No. PCT/EP2014/050304, filed Jan. 9, 2014, which claims priority under 35 U.S.C. §119 from German Patent Application No. 10 2013 100 243.9, filed Jan. 11, 2013, the entire disclosures of which are herein expressly incorporated by reference.

### BACKGROUND AND SUMMARY OF THE INVENTION

The present invention relates to a valve housing, in particular for a level control valve and/or a rapid action valve, and to a method for assembling a valve housing.

Pressure control valves and/or rapid action valves having two housing parts which are connected to each other by means of screwing or ultrasonic welding, for instance, are commonly available. A complex production process is thus necessary for fundamentally simple components.

The object of the present invention is to provide an improved valve housing, in particular for a level control valve and/or a rapid action valve, and an improved method for assembling a valve housing.

This and other objects are achieved by a valve housing, in particular for a level control valve and/or a rapid action valve, and by a method for assembling a valve housing, according to embodiments of the invention.

A particularly advantageous valve housing, in particular for a level control valve and/or a rapid action valve, in which the valve housing has a first housing part and a second housing part, is characterized in that the first housing part and the second housing part can be brought together in a meeting alignment with respect to each other in order to establish a mechanical contact between the first housing part and the second housing part, and are movable from the meeting alignment into a fixing alignment with respect to each other. The first housing part and the second housing part are configured to be mechanically fixed or fixable one to the other in the fixing alignment.

A version of the above-stated valve housing can advantageously be employed or used as part of a valve, in particular a level control valve and/or a rapid action valve. For instance, a valve or level control valve of this kind and/or a rapid action valve of this kind can be arranged or used in a vehicle. The vehicle can be in the form of an automobile, in particular a road bound automobile, such as a car, a truck or a commercial vehicle. The valve housing can be configured to encase and/or partially form a valve body of the valve. The valve body can have fluid channels and a shut-off element. The first housing part and the second housing part can be able to be joined together in order to form the finished valve housing or connect up the valve housing. The first housing part and the second housing part can be formed as part-shells of the valve housing. Here, the first housing part and the second housing part can be formed, for instance, also as half shells, a part of a cap or a part of a vessel, or the like. On at least one of the housing parts can also be arranged at least one element of the valve. In the meeting alignment, the first housing part and the second housing part can be brought into mechanical contact with each other in such a way that a desired or target volume range for the valve housing is attained. In the fixing alignment, the first housing part and the second housing part can be fastened or attached to each other.

A particularly advantageous method for assembling a valve housing, in particular for a level control valve and/or a rapid action valve, includes the following acts:

providing a valve housing having a first housing part and a second housing part;

bringing together of the first housing part and the second housing part of the valve housing in a meeting alignment (assembly orientation) with respect to each other, in order to establish a mechanical contact between the first housing part and the second housing part; and

moving the first housing part and the second housing part from the meeting alignment into a fixing alignment (securing orientation) with respect to each other, in order to mechanically fix or make fixable the first housing part and the second housing part one to the other in the fixing alignment for the assembly of the valve housing.

By implementation of the method, a version of the above-stated valve housing can advantageously be assembled or joined together.

A valve, in particular a level control valve and/or a rapid action valve, can also have a version of the above-stated valve housing.

According to embodiments of the present invention, housing parts, for instance a cap on a body, a valve housing of a valve, in particular of a level control valve, can advantageously be arranged and fixed one against another. In particular, the housing parts of the valve housing can be brought in a first alignment into mutual contact and, by means of a movement into a second alignment, can be fixed or made fixable to one another. For instance, the housing parts can be connected by turning and fixing of these same to form the valve housing, without the need for adhesive bonding or screwing for the connection of the housing parts.

Advantageously, according to embodiments of the present invention, a cost saving can be achieved by virtue of simplified connection methods for the housing parts. A cost saving is obtained, in particular, by eliminating screwing together or complex welding of the housing parts. In this way, a complexity of assembly of the valve housing and, where appropriate, a number of components can be reduced. A, where appropriate, advantageously releasable connection between the housing parts can be established.

According to one embodiment of the valve housing, the first housing part can have at least one first fixing portion and the second housing part can have at least one second fixing portion. In this case, the first housing part and the second housing part are configured to be mechanically fixed or fixable one to the other in the fixing alignment by way of interaction or by use of the at least one first fixing portion and the at least one second fixing portion. The at least one first fixing portion and the at least one second fixing portion can be configured for arrangement in the fixing alignment of the housing parts adjacent to each other or in mutual contact. Such an embodiment offers the advantage that a simple fixability of the two housing parts can be obtained by use of the fixing portions.

The first housing part and the second housing part can here be configured to be mechanically fixed one to the other by way of an interaction of the at least one first fixing portion and the at least one second fixing portion, upon a movement from the meeting alignment into the fixing alignment, once the fixing alignment is reached. In this case, by way of the interaction of the at least one first fixing portion and the at least one second fixing portion, a return movement from the fixing alignment into the meeting alignment can be blockable or blocked. A fixing of the first housing part and the second housing part one to the other can thus be effected if the first housing part and the second housing part are moved in contact with each other from the meeting alignment into the fixing alignment. Such an embodiment offers the advantage that the housing parts can be fixed one to the other by use of a self-fixing or auto-fixing characteristic or formation, and thus without the aid of further fastening devices or measures.

Also, the at least one first fixing portion can have a recess and the at least one second fixing portion can have a projection. In this case, in the fixing alignment, the projection can be arranged to engage in the recess in order to mechanically fix the first housing part and the second housing part one to the other in the fixing alignment. In particular, the first housing part and the second housing part can be fixed one to the other by snap locking of the fixing portions. Such an embodiment offers the advantage that a secure and, where appropriate, releasable fixing of the housing parts one to the other is obtainable.

Alternatively, the at least one first fixing portion can have a first receiving opening for a fastener and the at least one second fixing portion can have a second receiving opening for the fastener. In this case, in the fixing alignment, the first receiving opening can here be arranged in alignment with the second receiving opening for the reception of the fastener. Such an embodiment offers the advantage that the fixing portions of the housing parts are easily formable.

At least one fastener, which can be introduced into the first receiving opening and the second receiving opening in order to mechanically fix the first housing part and the second housing part one to the other in the fixing alignment and to block a return movement from the fixing alignment into the meeting alignment, can here be provided. The fastener can be in the form of a socket or the like. Such an embodiment offers the advantage that an easy to obtain and reliable fixing of the housing parts by means of cheap fastening devices is enabled.

In particular, the first housing part and the second housing part can be twistable relative to each other through at least 30 degrees for a movement from the meeting alignment into the fixing alignment. Additionally or alternatively, the first housing part and the second housing part can be twistable relative to each other through no more than 180 degrees for a movement from the meeting alignment into the fixing alignment. The first housing part and the second housing part, upon the movement from the meeting alignment into the fixing alignment, can here be arranged in contact with each other. For instance, the first housing part and the second housing part can be twistable relative to each other through 90 degrees for a movement from the meeting alignment into the fixing alignment. Such an embodiment offers the advantage that the movement from the meeting alignment into the fixing alignment, and thus the fixing or alignment of the housing parts for the purpose of fixing, can be easily obtained.

Furthermore, the first housing part and the second housing part can be formed of aluminum or at least one plastics material. In this case, the first housing part and the second housing part can be formed of aluminum or the same plastics material, or of a different plastics material. The first housing part and/or the second housing part can also be formed partially or fully of aluminum or the at least one plastics material. Such an embodiment offers the advantage that that the housing parts can be procured or produced at low cost.

According to one embodiment of the method, in the movement step, the first housing part and the second housing part can be mechanically fixed one to the other by way of an interaction of the same, once the fixing alignment is reached. Alternatively, a step of mechanically fixing the first housing part and the second housing part one to the other in the fixing alignment by use of a fastener can be provided. Thus, the housing parts are fixable either by auto-fixing without further components, or in a simple manner by a fastener.

Other objects, advantages and novel features of the present invention will become apparent from the following detailed description of one or more preferred embodiments when considered in conjunction with the accompanying drawings.

### BRIEF DESCRIPTION OF THE DRAWINGS

FIGS. 1A to 1C are representations of valves with a screwed together valve housing;

FIGS. 2A to 2B are representations of valves with a welded valve housing;

FIG. 3 is a representation of a valve having a valve housing according to an illustrative embodiment of the present invention;

FIGS. 4A and 4B are representations of a valve having a valve housing according to a further illustrative embodiment of the present invention; and

FIG. 5 is a flow chart of a method according to an illustrative embodiment of the present invention.

### DETAILED DESCRIPTION OF THE DRAWINGS

In the following description of the preferred illustrative embodiments of the present invention, the same or similar reference symbols are used for similarly acting elements represented in the various drawings, a repeat description of these elements being omitted.

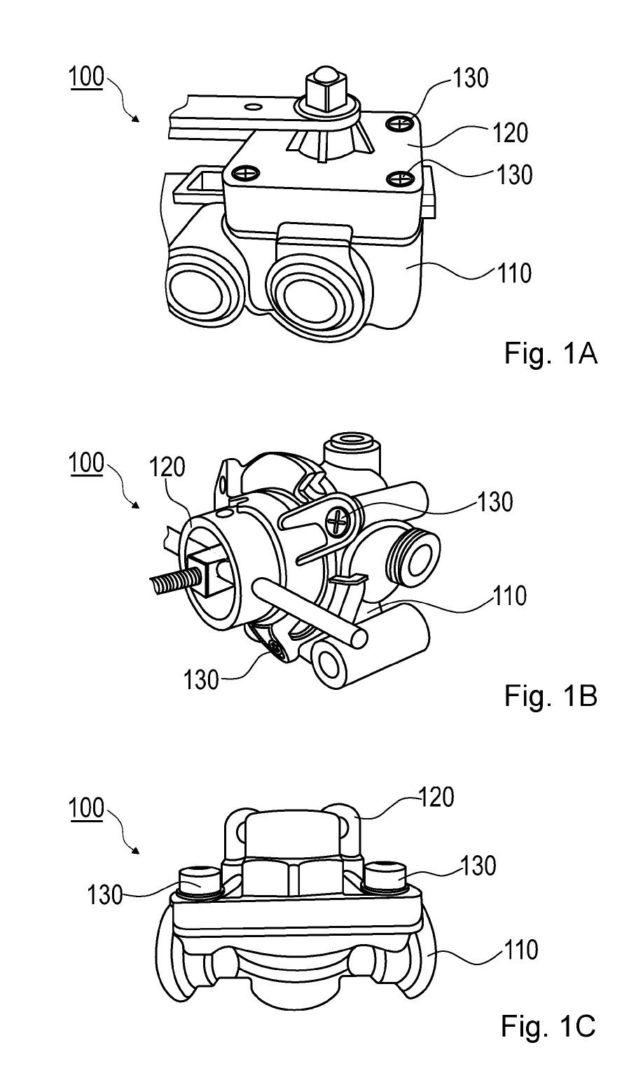

FIG. 1A shows a representation of a valve 100 having a screwed together valve housing. The valve 100 has a valve housing comprising a housing body 110 and a housing cap 120, which are connected to each other by the use of, by way of example, four fastening devices 130 or screws. Thus, the valve housing of the valve 100 is assembled by screwing together the housing body 110 and the housing cap 120 by way of the, by way of example, four fasteners 130.

FIG. 1B shows a representation of a further valve 100 having a screwed together valve housing. The valve 100 has a valve housing comprising a housing body 110 and a housing cap 120, which are connected to each other by the use of, by way of example, three fastening devices 130 or screws. Thus, the valve housing of the valve 100 is assembled by screwing together the housing body 110 and the housing cap 120 by way of the, by way of example, three fasteners 130.

FIG. 1C shows a representation of a further valve 100 having a screwed together valve housing. The valve 100 has a valve housing comprising a housing body 110 and a housing cap 120, which are connected to each other by the use of, by way of example, two fastening devices 130 or screws (visible in the representation). Thus, the valve housing of the valve 100 is assembled by screwing together the housing body 110 and the housing cap 120 by way of the, for example, three fastener 130.

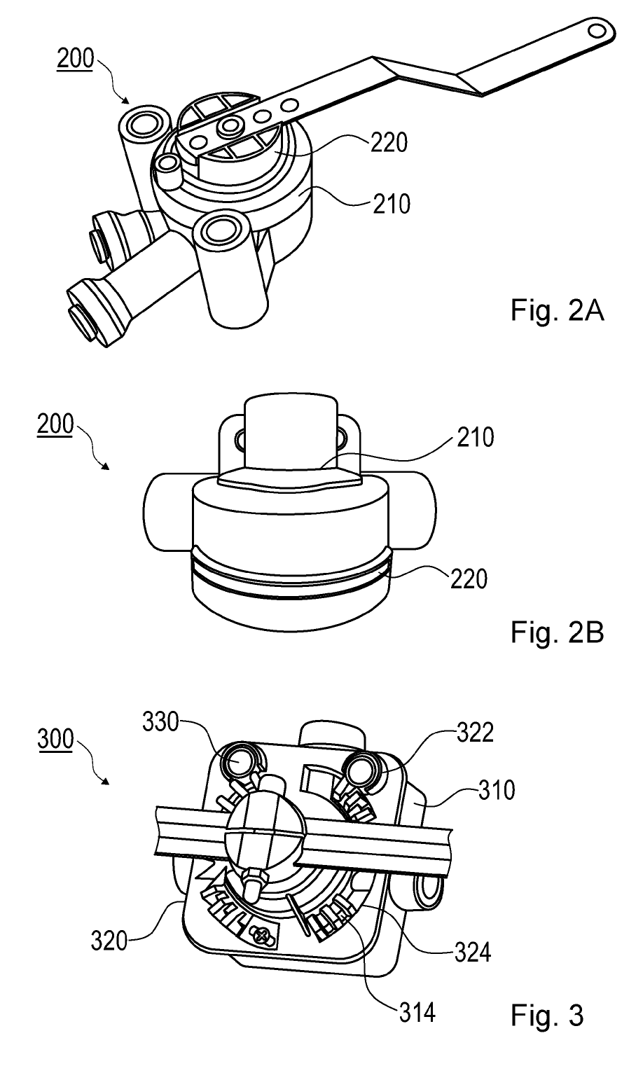

FIG. 2A shows a representation of a valve 200 having a welded valve housing. The valve 200 has a valve housing comprising a housing body 210 and a housing cap 220, which are connected to each other, by way of example, by way of ultrasonic welding. Thus, the valve housing of the valve 200 is assembled by an integrally bonded connection of the housing body 210 and the housing cap 220.

FIG. 2B shows a representation of a valve 200 having a welded valve housing. The valve 200 has a valve housing comprising a housing body 210 and a housing cap 220, which are connected to each other, by way of example, by way of ultrasonic welding. Thus, the valve housing of the valve 200 is assembled by an integrally bonded connection of the housing body 210 and the housing cap 220.

FIG. 3 shows a representation of a valve 300 having a valve housing according to an illustrative embodiment of the present invention. The valve 300 has a valve housing comprising a housing body 310 or first housing part, by way of example four alignment elements 314, a housing cap 320 or second housing part or a cover, by way of example two receiving openings 322 and, by way of example, four alignment cutouts 324. In addition, by way of example, two fasteners 330, in the form of, for instance, sleeves or sockets, are shown. The valve 300 is, for instance, a level control valve for automotive applications or vehicles. The valve housing comprising the housing body 310 and the housing cap 320 is made, for instance, of aluminum or a plastics material. The valve 300 is, for instance, a level control valve.

According to that illustrative embodiment of the invention which is shown in FIG. 3, the housing body 310 and the housing cap 320 of the valve housing of the valve 300 has a rectangular or square base area or a rectangular or square outline. The housing body 310 has the, by way of example, four alignment elements 314 and, by way of example, two further receiving openings, which in FIG. 3, for reasons of representation, are not shown or are concealed in the view by the housing cap 320 and the fasteners 330. The alignment elements 314 and the further receiving openings constitute first fixing portions of the valve housing. The alignment elements 314 are arranged along a common circular line, wherein each of the alignment elements 314 extends along a circular arc at a first angle at center of, by way of example, less than 90 degrees. The alignment elements 314 are formed as elongate rib elements. Even though it is not shown explicitly in FIG. 3, each of the alignment elements 314 has, for instance, a base portion and a cantilever portion. In this case, the cantilever portion is connected by the base portion to a surface of the housing body 310. The cantilever portion is formed such that it protrudes with respect to the base portion. A base area of the cantilever portion is larger than a base area of the base portion. Between a protruding part of the cantilever portion and the surface of the housing body 310 is thus configured an interspace.

According to that illustrative embodiment of the present invention which is shown in FIG. 3, the housing cap 320 of the valve housing of the valve 300 has a rectangular or square base area or a rectangular or square outline. The housing cap 320 has the, by way of example, two receiving openings 322 and the, by way of example, four alignment cutouts 324. The receiving openings 322 are arranged in different corner regions of the housing cap 320. Thus, a first of the receiving openings 322 is arranged in a first corner region of the housing cap 320 and a second of the receiving openings 322 is arranged in a second corner region, different from the first, of the housing cap 320. The receiving openings 322 and the alignment cutouts 324 constitute second fixing portions of the valve housing. The alignment cutouts 324 are arranged along a common circular line, wherein each of the alignment cutouts 324 extends along a circular arc at a second angle at center of, by way of example, less than 90 degrees. According to that illustrative embodiment of the present invention which is shown in FIG. 3, the second angle at center is greater than the first angle at center. Each of the alignment cutouts 324 has an insertion end and a stop end.

The fasteners 330 are arranged or accommodated in the receiving openings 322 of the housing cap 320 and in those further receiving openings of the housing body 310 which are concealed in FIG. 3. Here a first of the fasteners 330 is accommodated in a first of the receiving openings 322 of the housing cap 320 and a first of the further receiving openings of the housing body 310. In addition, a second of the fasteners 330 is accommodated in a second of the receiving openings 322 of the housing cap 320 and a second of the further receiving openings of the housing body 310.

In the representation of FIG. 3, the housing body 310 and the housing cap 320 are connected to each other or fixed one to the other. The housing body 310 and the housing cap 320 are thus assembled to form the valve housing. In this case, the housing body 310 and the housing cap 320 are arranged in a fixing alignment with respect to each other. In the fixing alignment of the housing body 310 and the housing cap 320, the receiving openings 322 are aligned with the further receiving openings in order to receive the fasteners 330. The fasteners 330 or sockets are inserted in the receiving openings 322 and further receiving openings. In the fixing alignment of the housing body 310 and of the housing cap 320 are also arranged the, by way of example, four alignment elements 314 of the housing body 310 in the, by way of example, four alignment cutouts 324 of the housing cap 320. Respectively one of the alignment elements 314 is here arranged in a respective one of the alignment cutouts 324. The alignment elements 314 here extend through the alignment cutouts 324. To be precise, in the fixing alignment, the alignment elements 314 are arranged in contact against the stop ends of the alignment cutouts 324. In particular, the protruding parts of the cantilever portions of the alignment elements 314 project beyond the respective stop ends of the alignment cutouts 324. According to that illustrative embodiment of the present invention which is shown in FIG. 3, regions of the housing cap 320 are here arranged at the stop ends of the alignment cutouts 324 between the protruding parts of the alignment elements 314 and the housing body 310.

For the assembly of the valve housing, the housing body 310 and the housing cap 320 are brought together, wherein these same are aligned in a meeting alignment with respect to each other. A mechanical contact is here established between the housing body 310 and the housing cap 320, wherein the alignment elements 314 of the housing body 310 are arranged in a region of the insertion ends in the alignment cutouts 324. The housing body 310 and the housing cap 320 are then subjected to a relative rotational movement from the meeting alignment into the above-described fixing alignment. Finally, the fasteners 330 are introduced into the receiving openings 322 of the housing cap 320 and into the further receiving openings of the housing body 310. In the fixing alignment, a relative rotary movement of the housing body 310 and of the housing cap 320 is prevented by way of the fasteners 330. In addition, in the fixing alignment, the housing body 310 and the housing cap 320 are held in contact with each other by the regions at the stop ends of the alignment cutouts 324 being clamped by the cantilever portions of the alignment elements 314. Thus the housing cap 320 or the cover is placed onto the housing body 310, rotated through, by way of example, 90 degrees relative to the housing body 310, and the fasteners 330 or sockets are inserted in order to prevent back-rotation of the housing cap 320.

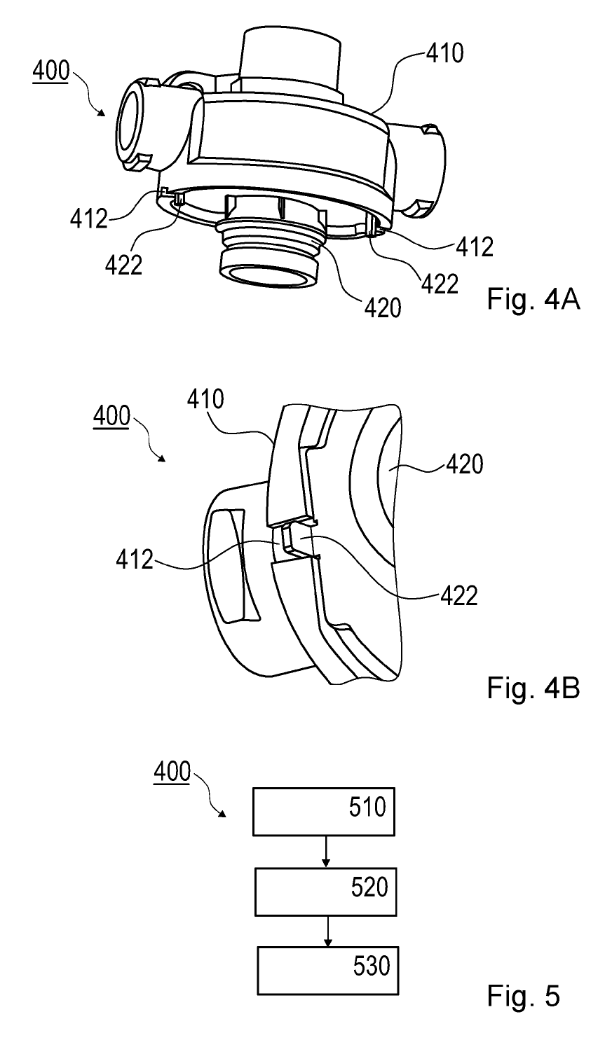

FIG. 4A shows a representation of a valve 400 having a valve housing according to a further illustrative embodiment of the present invention. The valve housing of the valve 400 has a housing body 410 having, by way of example, two recesses 412 or grooves and a housing cap 420 or a cover having, by way of example, two projections 422 or latching legs. The valve housing comprising the housing body 410 and the housing cap 420 is made, for instance, of aluminum or a plastics material. The valve 400 and the valve housing in FIG. 4A are similar, for instance, to the valve and the valve housing from FIG. 3, except that a first fixing portion of the valve housing has the recesses 412, a second fixing portion of the valve housing has the projections 422, no fastening devices are provided, and the housing body 410 and the housing cap 420 have a round or rounded base area or a round or rounded outline. The valve 400 is, for instance, a rapid action valve.

In the representation of FIG. 4A, the housing body 410 and the housing cap 420 are connected to each other or fixed one to the other. Thus the housing body 410 and the housing cap 420 are assembled to form the valve housing. In this case, the housing body 410 and the housing cap 420 are arranged in a fixing alignment with respect to each other. The recesses 412 are formed in a peripheral portion of the housing body 410. The projections 422 are formed in a peripheral portion of the housing cap 420.

FIG. 4B shows a cutout or partial portion of the valve 400 from FIG. 4A or a partial portion of the valve housing of the valve 400 from FIG. 4A. That partial portion of the valve housing of the valve 400 which is shown in FIG. 4B comprises partial regions of the housing body 410 and of the housing cap 420, one of the recesses 412 of the housing body 410 and one of the projections 422 of the housing cap 420. From FIG. 4B, it can be seen that, in that fixing alignment of the housing body 410 and the housing cap 420 which is represented in FIG. 4A and FIG. 4B, the projection 422 of the housing cap 420 is arranged such that it is accommodated or latched in the recess 412 of the housing body 410.

Even though it is not shown explicitly in FIG. 4B, adjacent to the recess 412, in the peripheral portion of the housing body 410, at least one fixing rail, and adjacent to the projection 422 in the peripheral portion of the housing cap 420, at least one fixing lug are formed. The first fixing portion of the valve housing has, in addition to the recesses 412, the at least one fixing rail. The second fixing portion of the valve housing has, in addition to the projections 422, the at least one fixing lug. In the fixing alignment of the housing body 410 and the housing cap 420, the at least one fixing lug is accommodated or arranged in the at least one fixing rail.

With reference to FIGS. 4A and 4B, for the assembly of the valve housing, the housing body 410 and the housing cap 420 are brought together, wherein the same, in a meeting alignment, are mutually aligned. A mechanical contact is here established between the housing body 410 and the housing cap 420, wherein the projections 422 are arranged outside the recesses 412. The housing body 410 and the housing cap 420 are then subjected to a relative rotational movement from the meeting alignment into the above-described fixing alignment. The projections 422 here latch into the recesses 412. In addition, the fixing lugs engage in the fixing rails and move along the fixing rails. In the fixing alignment, a relative rotary movement of the housing body 410 and the housing cap 420 is prevented by latching of the projections 422 into the recesses 412. In addition, in the fixing alignment, the housing body 410 and the housing cap 420 are held in contact with each other by the engagement and detention of the fixing lugs in the fixing rails. Thus the housing cap 420 or the cover is placed onto the housing body 410 and rotated through, by way of example, 90 degrees relative to the housing body 410, wherein the projections 422 latch into the recesses 412 in order to prevent back-rotation or further twisting of the housing cap 420 relative to the housing body 410. A fixing of components or housing components of the valve 400 or of a rapid action valve is achieved, wherein a plastic and/or elastic deformation is utilized as a rapid latch-in solution involving rotation and snap locking.

FIG. 5 is a flow chart of a method 500 according to an illustrative embodiment of the present invention. The method 500 serves for the assembly of a valve housing, in particular for a level control valve and/or a rapid action valve. The valve housing, which is assemblable by use of the method 500, is in the form, for instance, of the valve housing from FIG. 3 or 4A and 4B. The method 500 has an act 510 of providing a valve housing having a first housing part and a second housing part. The method 500 also includes an act 520 of bringing together the first housing part and the second housing part of the valve housing in a meeting alignment with respect to each other in order to establish a mechanical contact between the first housing part and the second housing part. In addition, the method 500 includes an act 530 of moving the first housing part and the second housing part from the meeting alignment into a fixing alignment with respect to each other in order to mechanically fix or make fixable the first housing part and the second housing part one to the other in the fixing alignment for the assembly of the valve housing.

The described illustrative embodiments are chosen only by way of example and can be mutually combined.

### REFERENCE SYMBOL LIST

100 valve
110 housing body
120 housing cap
130 fastener
200 valve
210 housing body
220 housing cap
300 valve
310 housing body
314 alignment element
320 housing cap
322 receiving opening
324 alignment cutout
330 fastener
400 valve
410 housing body
412 recess
420 housing cap
422 projection
500 method for assembling a valve housing
510 provision act
520 bringing together act
530 movement act
The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A valve housing, comprising:
a first housing part;
a second housing part, wherein
the first housing part and the second housing part are configured to be brought together in a meeting alignment with respect to one another in order to establish a mechanical contact between the first housing part and the second housing part, and
the first housing part and the second housing part are configured to be movable from the meeting alignment into a fixing alignment with respect to one another, in which the first housing part and the second housing part are mechanically fixed or fixable to one another in the fixing alignment.

2. The valve housing according to claim 1, wherein the valve housing is configured as a valve housing for a level control valve or a rapid action valve.

3. The valve housing according to claim 1, wherein:
the first housing part comprises a first fixing portion;
the second housing part comprises a second fixing portion, wherein
the first housing part and the second housing part are configured to be mechanically fixed or fixable to one another in the fixing alignment via interaction or use of the first fixing portion and the second fixing portion.

4. The valve housing according to claim 3, wherein:
the first housing part and the second housing part are configured to be mechanically fixed to one another via the interaction of the first fixing portion and second fixing portion upon movement from the meeting alignment into the fixing alignment once the fixing alignment has been reached, and
via the interaction of the first fixing portion and the second fixing portion, a return movement from the fixing alignment into the meeting alignment is blocked or blockable.

5. The valve housing according to claim 3, wherein:
the first fixing portion comprises a recess;
the second fixing portion comprises a projection, wherein
in the fixing alignment, the projection is arranged to engage in the recess in order to mechanically fix the first housing part and the second housing part to one another in the fixing alignment.

6. The valve housing according to claim 4, wherein:
the first fixing portion comprises a recess;
the second fixing portion comprises a projection, wherein
in the fixing alignment, the projection is arranged to engage in the recess in order to mechanically fix the first housing part and the second housing part to one another in the fixing alignment.

7. The valve housing according to claim 3, wherein:
the first fixing portion comprises a first receiving opening for a fastener; and
the second fixing portion comprises a second receiving opening for the fastener, wherein
in the fixing alignment, the first receiving opening is arranged in alignment with the second receiving opening in order for the fastener to be received in the first and second receiving openings.

8. The valve housing according to claim 7, wherein the fastener is introduced into the first receiving opening and the second receiving opening in order to mechanically fix the first housing part and the second housing part to one another in the fixing alignment and to block a return movement of the first housing part and the second housing part from the fixing alignment into the meeting alignment.

9. The valve housing according to claim 1, wherein
the first housing part and the second housing part are configured to be rotatable relative to one another through at least 30° for moving from the meeting alignment into the fixing alignment.

10. The valve housing according to claim 9, wherein the first housing part and the second housing part are rotatable relative to one another through no more than 180° for moving from the meeting alignment into the fixing alignment.

11. The valve housing according to claim 1, wherein the first housing part and the second housing part are formed of an aluminum or a plastic material.

12. A method of assembling a valve housing, the method comprising the acts of:
providing a first housing part and a second housing part of the valve housing;
bringing together the first housing part and the second housing part of the valve housing in a meeting alignment with respect to each other in order to establish mechanical contact between the first housing part and the second housing part; and
moving the first housing part and the second housing part from the meeting alignment into a fixing alignment with respect to one another in order to mechanically fix or make fixable the first housing part and the second housing part one to the other in the fixing alignment for assembling the valve housing.

13. The method according to claim 12, wherein the valve housing is configured for a level control valve or a rapid action valve.

14. The method according to claim 12, wherein the act of moving the first housing part and the second housing part from the meeting alignment into the fixing alignment is performed via an interaction of the first housing part and the second housing part to mechanically fix the first and second housing parts to one another once the fixing alignment is reached.

15. The method according to claim 12, further comprising the act of:
mechanically fixing the first housing part and the second housing part to one another in the fixing alignment via a fastener.
